(19) United States
(12) Patent Application Publication
(10) Pub. No.: US 2026/0175397 A1
(43) Pub. Date: Jun. 25, 2026

(54) Hand-Held Power Tool

(71) Applicant: Robert Bosch GmbH, Stuttgart (DE)

(72) Inventors: Tobias Herr, Grafenau (DE); Jens Blum, Filderstadt (DE)

(21) Appl. No.: 19/421,748

(22) Filed: Dec. 16, 2025

(30) Foreign Application Priority Data
Dec. 20, 2024 (DE) 10 2024 139 350.5

(51) Int. Cl. B25F 5/00; B25B 21/02

(52) U.S. Cl. CPC B25F 5/001; B25B 21/02

(57) ABSTRACT

A hand-held power tool includes a housing, a drive motor having a drive shaft, a transmission driven by the drive shaft, and an intermediate shaft driven by the transmission. The intermediate shaft includes a guiding element, and a percussion mechanism with a striker and an anvil. The guiding element is configured to guide the striker. The hand-held power tool further includes a centering device configured to center the intermediate shaft, and a tool holder driven by the percussion mechanism for receiving an insertion tool. The diameter of the guiding element and the diameter of the centering device are substantially the same size.

This application claims priority under 35 U.S.C. § 119 to application no. DE 10 2024 139 350.5, filed on Dec. 20, 2024 in Germany, the disclosure of which is incorporated herein by reference in its entirety.

The present disclosure relates to a hand-held power tool.

### BACKGROUND

A hand-held power tool with a drive housing, with a percussion mechanism housing and with a rotary percussion mechanism is already disclosed in DE 10 2017 211 774 A1.

### SUMMARY

The present disclosure presents a hand-held power tool with a housing, a drive motor comprising a drive shaft, a transmission driven by the drive shaft, an intermediate shaft driven by the transmission comprising a guiding element, a percussion mechanism comprising a striker and an anvil, wherein the guiding element is configured to guide the striker, a centering device configured to center the intermediate shaft, and a tool holder driven by the percussion mechanism for receiving an insertion tool. It is proposed that the diameter of the guiding element and the diameter of the centering device are substantially the same size.

The disclosure provides a compact yet robust hand-held power tool. The prior art discloses either the intermediate shaft or the anvil having a centering element, for example a pin, for centering the anvil or the intermediate shaft. In the present disclosure, the centering element from the prior art is not needed for centering, as a result of which the hand-held power tool may be constructed more compactly. This is achieved by having the diameter of the guiding element and the diameter of the centering device substantially equal in size.

The hand-held power tool may be configured as an electrically operated hand-held power tool. The electrically operated hand-held power tool may be configured as a plug-in or a cordless hand-held power tool. For example, the hand-held power tool may be designed as a screwdriver, a drill screwdriver, an impact drill screwdriver, an impact screwdriver or a rotary impact screwdriver.

The housing of the hand-held power tool is configured to at least partly accommodate the drive motor, the transmission, the percussion mechanism and the tool holder. The housing may be configured as a shell housing with two half shells.

The hand-held power tool has a drive unit. The drive unit comprises the drive motor and the transmission. The drive motor may be an electrically commutated motor. In particular, the drive motor may be designed as at least one electric motor. The drive motor is configured such that it may be actuated via a manual switch. When the manual switch is actuated by a user, the drive motor is switched on and the hand-held power tool is put into operation. If the manual switch is not further actuated by the user, the drive motor is switched off. The drive motor may preferably be electronically controlled and/or regulated in such a way that a reversing mode and a specification for a desired rotational speed may be implemented. In reversing mode, the drive motor may be switched between a clockwise direction of rotation and a counterclockwise direction of rotation. To switch the drive motor in reversing mode, the hand-held power tool may comprise a rotation direction switching element, in particular a rotation direction changeover switch.

The drive motor comprises the drive shaft. The drive shaft is mounted in the housing via at least one drive shaft bearing. The drive motor may actuate the transmission, the percussion mechanism and/or the tool holder by means of the drive shaft. The drive shaft bearing may be configured as a ball bearing, a rolling bearing, a needle bearing or a sliding bearing, for example. The drive shaft bearing may be located at an end of the drive motor facing the tool holder. The drive shaft bearing may be located, in particular in the axial direction, between the transmission and the drive motor. The drive shaft may project into the intermediate shaft. The drive shaft bearing may be located in the intermediate shaft so that the drive shaft is mounted in the intermediate shaft via the drive shaft bearing. A further drive shaft bearing may also be provided to support the drive shaft. The further drive shaft bearing may be located at the end of the drive motor facing away from the tool holder. The further drive shaft bearing may be configured as a ball bearing, a rolling bearing or a sliding bearing, for example. The drive shaft may have a sealing element. The sealing element may be configured to at least partially seal off the transmission and/or the percussion mechanism from the drive motor. The sealing element may be circumferentially arranged about the drive shaft. The sealing element may be connected to the transmission cover or to the drive shaft. The sealing element may engage with a toothing of the drive shaft. The sealing element may have a corresponding toothing. The sealing element may then be arranged axially between the drive motor, in particular a spacer element of a rotor of the drive motor, and the transmission, in particular the planetary gear or gears.

The drive shaft is configured to drive the transmission. The transmission comprises a transmission housing, a transmission cover, and a ring gear. The transmission may be configured as at least one planetary gear, wherein it may, for example, be shiftable. In the case of a shiftable transmission, it is possible to switch between at least two gear stages by means of at least one gear shifting element, in particular a gear shifter. The ring gear may abut the transmission housing, in particular axially. The transmission cover is designed to close off the transmission housing, at least in sections. In addition, the transmission cover may be configured to at least partially engage the ring gear. The transmission cover may be configured to at least partially engage an inner circumference of the ring gear.

The hand-held power tool comprises a percussion mechanism. The percussion mechanism generates high torque peaks during operation to loosen tight connecting means or to fasten connecting means or to drill holes. The percussion mechanism may be connected to the drive motor by means of the transmission. The percussion mechanism may, for example, be designed as a rotational percussion mechanism, a detent percussion mechanism, a rotary percussion mechanism, a V-groove percussion mechanism or a hammer percussion mechanism. The transmission and/or the percussion mechanism may comprise the intermediate shaft. For example, the intermediate shaft may accommodate planetary gears of the transmission. It is possible for the intermediate shaft to have a planet carrier for receiving the planetary gears of the planetary transmission. Furthermore, the intermediate shaft may at least partially actuate the percussion mechanism. The percussion mechanism may comprise a percussion mechanism housing and/or a percussion mechanism cover. It is possible for both the transmission housing and the percussion mechanism housing, as well as the transmission cover and the percussion mechanism cover, to be made of one piece. Furthermore, the percussion mechanism may comprise the striker, at least one percussion mechanism spring, and least one percussion mechanism bearing and at least one striker cam. The striker and the percussion mechanism spring may be located substantially within the percussion mechanism housing. The percussion mechanism spring may, for instance, be configured as a spiral spring, a barrel-shaped spring, a conical spring, a chimney spring or a profiled spring. The percussion mechanism cover, particularly in the axial direction, may be positioned between the percussion mechanism, specifically the striker and the percussion mechanism spring, and the drive motor. The percussion mechanism bearing is configured to connect the striker to the intermediate shaft. For example, two percussion mechanism bearings may be provided. In addition, the percussion mechanism comprises the anvil having an anvil body and at least one anvil cam. For example, two anvil cams may be configured. The percussion mechanism is configured such that the striker drives the anvil cam by means of the striker cam. As the striker rotates during non-impact operation of the percussion mechanism, this rotation is transferred via the striking cam to the anvil cam. During impact operation of the percussion mechanism, the striking cam strikes the anvil cam in a circumferential direction so as to drive it further. For example, two striking cams may be provided. The toolholder may be connected to the anvil. It is possible for the toolholder to form the anvil. It is further conceivable that the toolholder and the anvil are of one piece.

The intermediate shaft may be driven by means of the transmission. The intermediate shaft comprises the guiding element. The guiding element is configured to guide the striker of the percussion mechanism, at least axially. The guiding element is configured to guide the striker during both non-impact operation of the percussion mechanism and impact operation of the percussion mechanism. As the striker is wound up during operation of the percussion mechanism, the guiding element guides the striker axially towards the transmission or drive motor, respectively. For example, the guiding element may be formed as a cylinder or hollow cylinder. The guiding element has a guide surface. The guide surface is configured such that the striker is at least axially guidable on the guide surface. The guide surface may be formed on an outer circumference of the intermediate shaft.

The centering device is configured to center the intermediate shaft. The centering device allows the intermediate shaft to be centered during both non-impact operation and impact operation. The intermediate shaft may be centered relative to a tool axis. The centering device may be configured on the intermediate shaft and/or on the tool holder. The diameter of the guiding element and the diameter of the centering device are substantially equal in size. It is also conceivable that the two diameters are the same size. Smaller deviations of the two diameters of up to 2 mm are also to be considered equal in size.

The hand-held power tool comprises the tool holder. The tool holder may be configured as an internal tool holder, for example a bit holder, and/or as an external tool holder, for example a socket holder. It is also conceivable that the tool holder is configured as a drill chuck. The tool holder may accommodate insertion tools, such as screwdriver bits or sockets, so that a user may produce screw connections between a fastening element and a fastening holder. The hand-held power tool may comprise a tool axis. An axis of rotation of the tool holder may form the tool axis. “Axial” is in particular intended to be understood as substantially parallel to the tool axis. Whereas “radial” is intended to be understood as substantially perpendicular to the tool axis. The tool holder may be rotatably mounted in the percussion mechanism housing and/or the transmission housing by means of a tool holder bearing element. For example, the tool holder bearing element may be configured as a sliding bearing or at least one ball bearing. It is possible for the tool holder to comprise, for example, two or three tool holder bearing elements.

A bearing device for supporting the intermediate shaft may be provided. The transmission may be configured to form the bearing device.

The hand-held power tool further comprises a power supply, wherein the power supply is provided for cordless operation by means of rechargeable batteries, in particular hand-held power tool rechargeable battery packs, and/or for plug-in operation. In a preferred embodiment, the power supply is configured for cordless operation. In the context of the present disclosure, a “hand-held power tool rechargeable battery pack” is intended to be understood as a combination of at least one battery cell and a rechargeable battery pack housing. The hand-held power tool rechargeable battery pack is advantageously configured for supplying power to commonly available cordless hand-held power tools. The at least one battery cell may, for instance, be configured as a Li-ion battery cell having a nominal voltage of 3.6 V. The hand-held power tool rechargeable battery pack may include up to ten battery cells, for example, although a different number of battery cells is conceivable too. Both one embodiment as a cordless hand-held power tool and operation as a plug-in hand-held power tool are sufficiently well-known to those skilled in the art, so the specifics of the power supply will not be discussed here.

The hand-held power tool may have a control unit at least for controlling the drive unit. The control unit may be located in the housing, for example in a handle of the hand-held power tool or in a region of a power supply interface.

In one embodiment of the hand-held power tool, the centering device and the anvil are arranged at least partially overlapping each other. The centering device and the anvil, in particular the anvil cam, at least partially overlap, in particular axially. The intermediate shaft may be arranged at least partially overlapping the anvil, in particular the anvil cam.

In one embodiment of the hand-held power tool, the centering device comprises a centering receptacle configured to at least partially encompass the intermediate shaft. The anvil may at least partially form the centering device. The centering receptacle may be configured as a centering recess. The centering receptacle may be configured opposite the tool holder. For example, the centering receptacle may be pot-like, cup-like, or pan-like. A diameter of the centering receptacle may be substantially the same as the diameter of the guiding element, such that the intermediate shaft is receivable via the guiding element. At the same time, the intermediate shaft may also be rotatable relative to the tool holder. The centering receptacle may at least partially encompass the intermediate shaft, in particular the guiding element, such that they are arranged overlapping one another, in sections, in particular axially. The centering receptacle may be arranged radially between the intermediate shaft and the striker, in particular the striking cam.

In one embodiment of the hand-held power tool, the centering device comprises a centering collar configured to at least partially abut the intermediate shaft. The centering collar may be formed on the anvil. For example, the centering collar may be annular or configured as a circumferential web. The centering collar may at least partially abut the intermediate shaft, in particular the guiding element. As a result, the centering of the intermediate shaft may take place. The toolholder may be centered over the tool holder bearing element such that centering of the intermediate shaft via the centering collar is possible. The centering collar may at least partially enclose the centering receptacle. The anvil cam may be arranged and/or formed axially between the centering collar and the tool holder. The centering device with the centering receptacle and the centering collar may allow a sufficiently long guide length for the intermediate shaft to be provided, in order to ensure centering.

In one embodiment of the hand-held power tool, the centering collar can be arranged at least partially overlapping the striker. The centering collar may be formed on the anvil. The centering collar may be annular or configured as a circumferential web, for example. During non-impact operation, the centering collar may be arranged overlapping the striker, in particular the striking body. The centering collar may extend into a closed striker diameter in a striker position. The centering collar may be arranged radially between the intermediate shaft and the striker, in particular the striking body.

In one embodiment of the hand-held power tool, the intermediate shaft comprises at least one abutment element configured to at least partially abut the centering device and receive at least axial forces from the centering device. The abutment element may be formed on an end face of the intermediate shaft. The end face may be facing toward the tool holder. The abutment element may be configured at least partially in an annular shape, by way of example. It is possible that the abutment element is also formed in a bar-like fashion. The abutment element may abut the centering device such that the axial forces from the tool holder may be transferred to the intermediate shaft via the centering device. The axial forces may then be passed on to the transmission housing via the intermediate shaft. The abutment element may abut the centering device directly. The centering receptacle may receive the abutment element for this purpose. The abutment element may then abut in the centering receptacle.

In one embodiment of the hand-held power tool, the abutment element is arranged at least partially overlapping the anvil. The abutment element is arranged at least partially axially overlapping the anvil, in particular the anvil cam. The abutment element and anvil cam overlap such that a more compact design is allowed.

In one embodiment of the hand-held power tool, the intermediate shaft comprises a compensating element configured to compensate for imbalances. The compensating element may be formed as a conical bore in the intermediate shaft. The compensating element allows rotational accuracy to be increased and the imbalances to be reduced.

In one embodiment of the hand-held power tool, the centering device comprises a centering element configured to at least partially engage the intermediate shaft. The centering element may be formed by the anvil. It is possible that the centering element and the anvil are of one piece. For example, the centering element may be configured as a centering cone. The centering element may at least partially engage the compensating element of the intermediate shaft. The centering element may abut the compensating element of the intermediate shaft. Thus, the centering cone may abut the conical bore and additionally center the intermediate shaft. The abutment element of the intermediate shaft may at least partially encompass the centering element in the circumferential direction.

In one embodiment of the hand-held power tool, the centering device comprises a collection element configured to collect at least lubricants. The collection element may be formed by the anvil. For example, the collection element may be configured as a blind hole with a centering bore. The collection element allows the lubricants to be at least partially collected within the percussion mechanism. In addition, the collection element allows higher rotational accuracy. The collection element may be configured opposite the compensating element.

In one embodiment of the hand-held power tool, the bearing device comprises an axial bearing device that is formed at least partially, in particular axially, between the intermediate shaft and the transmission cover. This can be understood as axially relative to the tool axis and/or the drive shaft. The axial bearing device allows axial bearing of the intermediate shaft. The axial bearing device is configured such that the intermediate shaft can be oriented relative to the transmission cover.

In one embodiment of the hand-held power tool, the axial bearing device comprises at least one bearing element formed circumferentially to the drive shaft. The bearing element may be formed on the intermediate shaft, the planet carrier, and/or on the transmission cover. It is possible for the bearing element to be connected to the intermediate shaft, the planet carrier, and/or the transmission cover, which is also conceivable as one piece. The bearing element may be formed in the circumferential direction with respect to the drive shaft or the tool axis. The bearing element may be configured as a ring, bar, or protrusion that is at least partially circumferential.

In one embodiment of the hand-held power tool, the bearing element is arranged radially between the drive shaft and the ring gear. In this case, radial is understood as radial to the tool axis or to the drive shaft. The bearing element may be arranged and formed on the intermediate shaft radially between the drive shaft and the ring gear. It is also possible that the bearing element and the intermediate shaft may be of one piece. It is conceivable that the bearing element may be arranged radially between the drive shaft and planetary gear bolts. The planetary bolts are configured to rotatably position the planet gears on the planet carrier.

In one embodiment of the hand-held power tool, the axial bearing device comprises at least one bearing receptacle configured to accommodate the at least one bearing element. The bearing receptacle may be arranged and/or formed on the transmission cover, the intermediate shaft, and/or the planet carrier. It is also possible that the bearing receptacle may be one piece with the transmission cover, the intermediate shaft, and/or the planet carrier. The bearing receptacle may receive the bearing element such that the intermediate shaft is supported relative to the transmission cover. The bearing element and the bearing receptacle may allow for low frictional support of the intermediate shaft. The bearing receptacle may be configured in the circumferential direction with respect to the drive shaft. The bearing receptacle may be configured as a bearing surface. The bearing surface may be in the form of a substantially planar surface, for example annular or disc-shaped. The bearing receptacle may be formed by, for example, the transmission cover. The bearing receptacle and the transmission cover may then be one piece. It is possible for the bearing element to be formed by a separate component. For example, the separate component may be annular. In addition, the separate component may be arranged axially between the transmission cover and the intermediate shaft, in particular the planet carrier. Accordingly, the transmission cover may then have a receptacle for the separate component.

In one embodiment of the hand-held power tool, the axial bearing element has at least one further bearing element, wherein the bearing element is arranged radially between the drive shaft and the further bearing element. The further bearing element may also be arranged in the circumferential direction with respect to the drive shaft. The further bearing element may be configured analogously to the bearing element. The bearing receptacle may then be configured such that both the bearing element and the further bearing element are receivable.

In one embodiment, the bearing device comprises at least one lubricant receptacle configured to receive lubricant of the bearing device. The lubricant receptacle may receive the lubricant, such as grease, like transmission grease. The lubricant receptacle may be arranged radially between the bearing element and the further bearing element. The lubricant receptacle may, for example, be configured as an at least partially circumferential groove. The lubricant receptacle may be arranged and/or formed on the intermediate shaft, the planet carrier, and/or the transmission cover. It is also possible for the lubricant receptacle to be one piece with the intermediate shaft, the planet carrier, and/or the transmission cover.

In one embodiment of the hand-held power tool, the bearing device comprises a radial bearing device configured at least partially, in particular radially, between the intermediate shaft and the ring gear. The radial bearing device allows radial support of the intermediate shaft within the transmission housing. The bearing device comprises the axial bearing device and the radial bearing device.

In one embodiment of the hand-held power tool, at least one planetary gear of the transmission and the ring gear are configured to form the radial bearing device. The transmission may be configured as the planetary transmission, wherein the planetary transmission comprises at least one planetary gear. It is possible that a plurality of planetary gears are provided for the planetary transmission, for example two, three, or more than three planetary gears. An example of three planetary gears is provided herein. The planetary gears and the ring gear are configured to form the radial bearing device and thus receive radial forces during operation of the intermediate shaft and introduce them into the transmission housing. The radial bearing is carried out substantially indirectly via the three planetary gears.

In one embodiment of the hand-held power tool, at least one width of a planet carrier flange of the transmission is less than or substantially equal to at least one width of a planetary gear of the transmission. The planet carrier flange is a flange of the planet carrier of the transmission. It is possible that the planet carrier flange may also be an intermediate shaft flange. The planetary gear comprises a planetary gear diameter in addition to the width.

In one embodiment of the hand-held power tool, an opening of the transmission cover is smaller than or substantially equal to an opening of the intermediate shaft. The transmission cover has a central opening. The drive shaft is guided into the transmission through the central opening. The intermediate shaft also comprises a central opening. Through the central opening of the intermediate shaft, the drive shaft is guided into the transmission. A diameter of the opening of the transmission cover is less than or substantially equal to a diameter of the opening of the intermediate shaft. The opening of the transmission cover and the opening of the intermediate shaft are arranged axially adjacent to one another. The opening of the intermediate shaft may comprise a ramp in which the diameter of the opening of the intermediate shaft increases from motor side to tool side.

In one embodiment of the hand-held power tool, the transmission cover is arranged at least partially within the ring gear. The ring gear comprises the inner circumference and an internal space. The transmission cover is arranged at least partially in the inner circumference and the internal space. The transmission cover is configured to close the ring gear in the direction of the drive motor.

In one embodiment of the hand-held power tool, the transmission cover comprises a transmission receptacle that is configured to at least partially receive the planet carrier. The transmission cover may form the transmission receptacle. For example, the transmission receptacle may be configured in the shape of a bowl, pot, or pan. The transmission cover and the transmission receptacle may be one piece. The transmission receptacle may at least partially receive the planet carrier of the transmission, at least in sections. The planet carrier and the transmission receptacle may be spaced apart from one another and/or abut one another. The intermediate shaft may form the planet carrier. The transmission receptacle may also be configured as an intermediate shaft receptacle. The intermediate shaft and the intermediate shaft receptacle may be spaced apart from one another and/or abut one another.

In one embodiment of the hand-held power tool, in particular axially, a play compensation element is arranged between the transmission cover and the ring gear. The play compensation element is configured to compensate for axial play and/or radial play. The play compensation element may compensate for the axial play by applying an axial force to the ring gear, to the intermediate shaft, from the intermediate shaft to the anvil, and correspondingly to the tool holder. Thus, the axial play between the transmission housing, the intermediate shaft and the anvil is reduced, in particular to substantially 0 mm. The play compensation element is configured to pretension the intermediate shaft against the anvil. Furthermore, the play compensation element is configured to seal the transmission from grease leakage. The play compensation element is formed as, for example, a spring element, for example an O-ring. The transmission cover may be arranged axially between the play compensation element and the planetary gear of the planetary transmission. The play compensation element may abut the transmission receptacle. The play compensation element may be radially arranged between the transmission receptacle and the ring gear. As a result, the play compensation element may radially center the transmission cover. Additionally, the play compensation element attenuates minor movements of the transmission cover.

In one embodiment of the hand-held power tool, the transmission cover is configured to apply force to a ledge of the ring gear. The ring gear comprises the at least partially circumferential ledge. The ring gear may form the ledge, wherein this may also be of one piece. It is possible that the ledge of the ring gear is also configured circumferentially. The ledge of the ring gear is a ledge formed in the direction of the drive shaft. The ledge of the ring gear may thereby be configured radially in the direction of the drive shaft. The transmission cover may be configured to apply force to the ledge of the ring gear via the play compensation element. The transmission cover may abut the play compensation element. The play compensation element may abut the ledge of the ring gear. It is also conceivable that the transmission cover abuts the ring gear. The ring gear may be configured to axially secure the transmission cover at least in part via the ledge.

In one embodiment of the hand-held power tool, an outer diameter of the transmission cover is less than a base diameter of the ring gear. The diameter of the base is the largest internal diameter of the ring gear. The outer diameter of the transmission cover is smaller than the base diameter such that the transmission cover can be inserted within the ring gear.

In one embodiment of the hand-held power tool, the transmission cover is configured as a thrust washer. For example, the thrust washer may be formed as thin sheet metal, or in a disc-like, annular, bowl-like, or plate-like manner.

In one embodiment, a wall thickness of the transmission cover, in particular the thrust washer, is less than 1.5 mm. The wall thickness of the transmission cover may be a wall thickness of the thrust washer. It is also possible that the wall thickness of the transmission cover is less than 1 mm.

In one embodiment of the hand-held power tool, the transmission cover, in particular the thrust washer, has a sprocket configured to engage the ring gear. The sprocket may be formed on an outer circumference of the transmission cover. It is possible that the sprocket and transmission cover are one piece. The sprocket may be configured to be directed radially outward. Thus, the sprocket may be formed radially towards the housing and/or radially away from the drive shaft. The sprocket of the transmission cover may be insertable into a sprocket of the ring gear. Thus, the sprocket of the transmission cover and the sprocket of the ring gear may interlock with toothing.

In one embodiment of the hand-held power tool, an intermediate shaft bearing element is arranged between the intermediate shaft and the transmission cover. The intermediate shaft bearing element can be arranged radially between the intermediate shaft and the transmission cover. The intermediate shaft bearing element may, for example, be a ball bearing or a slide bearing. The intermediate shaft may have a bearing receptacle in this case, which may be configured as a circumferential collar, for example. The planetary gears may be arranged, in particular axially, between the intermediate shaft bearing element and the drive shaft bearing. The transmission cover may include an intermediate shaft bearing receptacle. The intermediate shaft bearing element may be arranged radially between the bearing receptacle and the intermediate shaft bearing receptacle.

In one embodiment of the hand-held power tool, the ring gear has a top diameter, by means of which the transmission cover may be at least partially guided. The top diameter is the smallest diameter of the sprocket of the ring gear. The transmission cover may abut at the top diameter with an outer diameter. The transmission cover may thereby be guided at least radially. A damping element may be arranged between the transmission cover and the ring gear.

### BRIEF DESCRIPTION OF THE DRAWINGS

The disclosure is explained below with reference to preferred embodiments. The drawings show:

FIG. 1 a schematic view of a hand-held power tool according to the disclosure;

FIG. 2a a section of a longitudinal cross-section of a first embodiment of the hand-held power tool;

FIG. 2b a cross section of the first embodiment of the hand-held power tool;

FIG. 2c a section of a longitudinal cross-section of the first embodiment of the hand-held power tool;

FIG. 2d a perspective view of a tool holder having an anvil of the first embodiment of the hand-held power tool;

FIG. 3a a first perspective view of an intermediate shaft of the first embodiment of the hand-held power tool;

FIG. 3b a second perspective view of the intermediate shaft of the first embodiment of the hand-held power tool;

FIG. 4a a section of a longitudinal cross-section of a second embodiment of the hand-held power tool;

FIG. 4b a perspective view of a tool holder having an anvil of the second embodiment of the hand-held power tool;

FIG. 5a a first perspective view of a transmission cover of the hand-held power tool;

FIG. 5b a second perspective view of the transmission cover of the hand-held power tool;

FIG. 6 a section of a longitudinal cross-section of the hand-held power tool;

FIG. 7 a section of a longitudinal cross-section of a third embodiment of the hand-held power tool;

FIG. 8a a section of a longitudinal cross-section of a fourth embodiment of the hand-held power tool; and

FIG. 8b a transmission cover of the fourth embodiment of the hand-held power tool.

### DETAILED DESCRIPTION

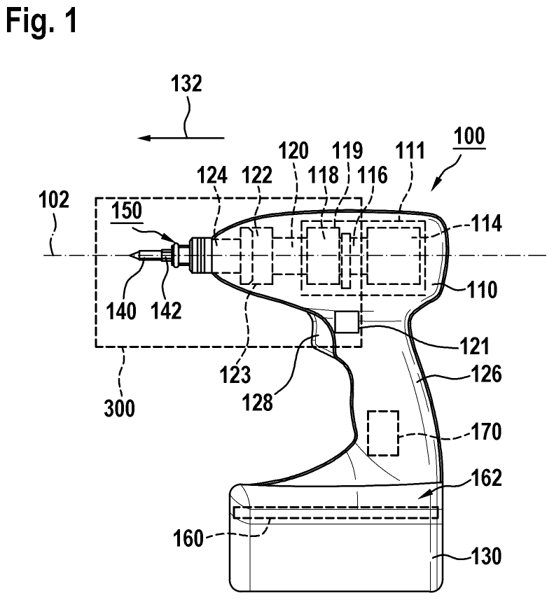

FIG. 1 shows a hand-held power tool 100 according to the disclosure, which is configured as a cordless rotary impact screwdriver 100, for example. The hand-held power tool 100 comprises an output shaft 124 and a tool holder 150. The hand-held power tool 100 comprises a housing 110 with a handle 126. To provide a power supply that is independent of the electric grid, the hand-held power tool 100 may be mechanically and electrically connected to a power supply for cordless operation, so that the hand-held power tool 100 is configured as a cordless hand-held power tool 100. A hand-held power tool rechargeable battery pack 130 is used here as the power supply. The present disclosure is not limited to cordless hand-held power tools, however, but may also be used for those dependent on the electric grid, i.e. plug-in hand-held power tools.

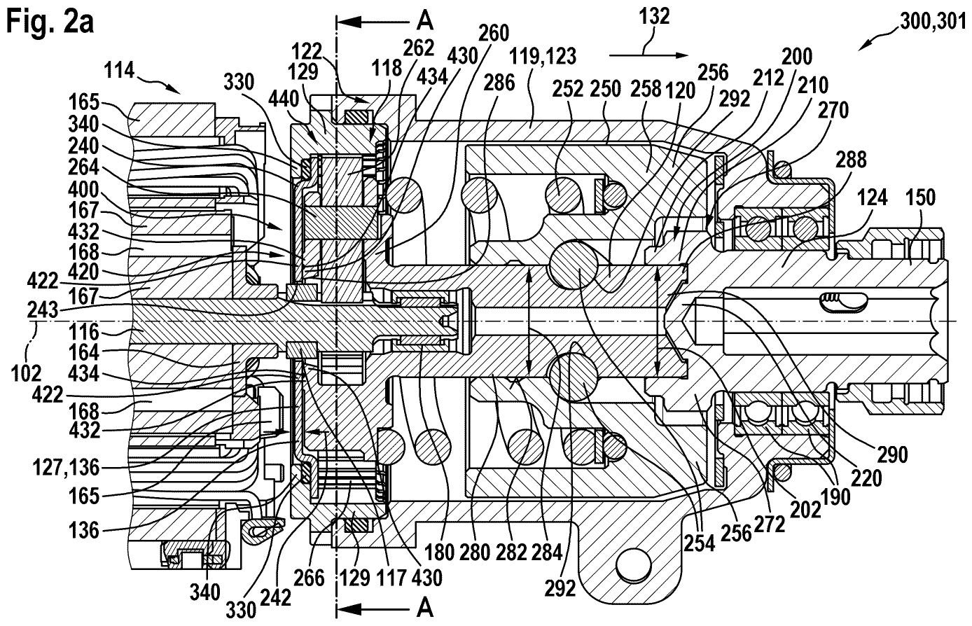

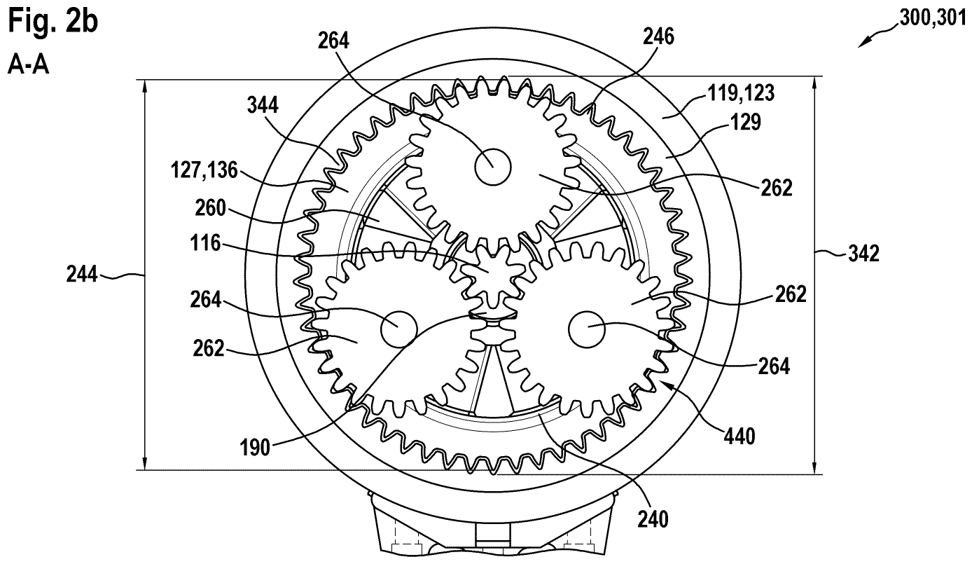

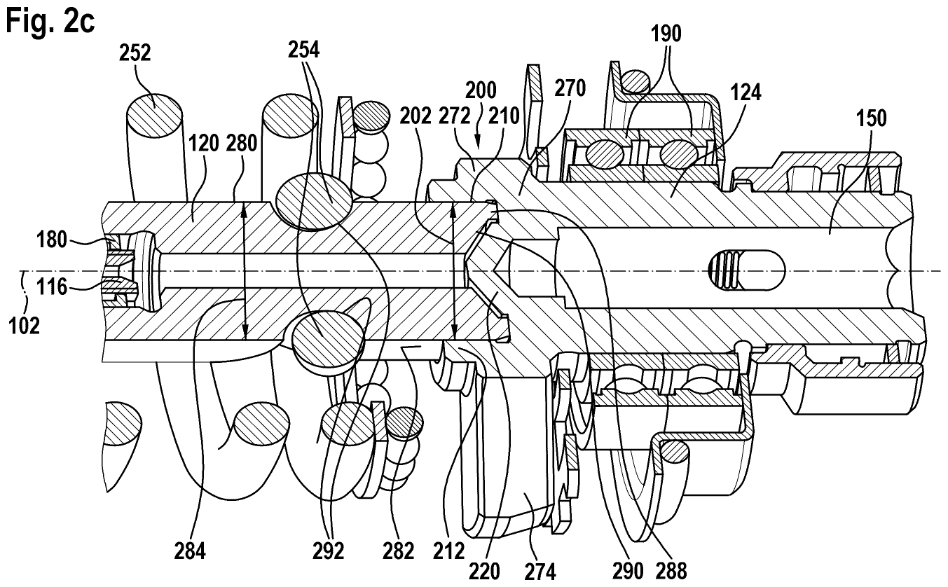

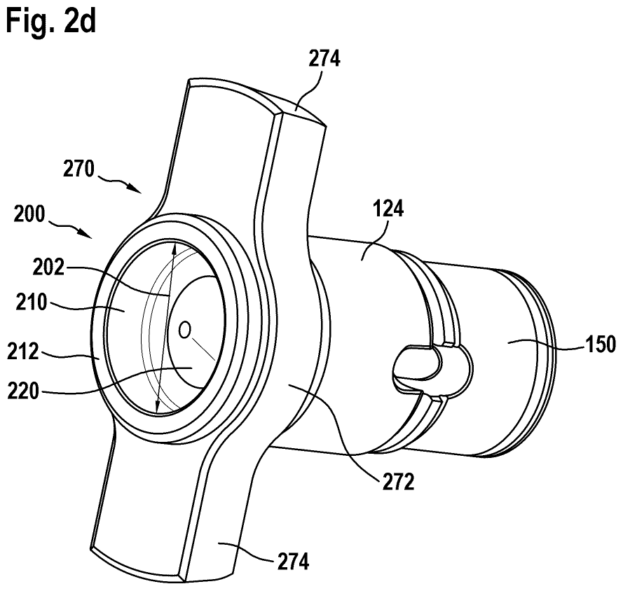

The housing 110 comprises a drive unit 111. The drive unit 111 is located in the housing 110. The drive unit 111 comprises an electrically commutated drive motor 114, which is supplied with power by the hand-held power tool rechargeable battery pack 130, and a transmission 118. The drive motor 114 comprises a stator 165, motor terminals 166, a rotor 167 and rotor magnets 168; see also FIG. 2. The transmission 118 is designed as at least one planetary gear. The drive motor 114 is designed such that it may be actuated, for example via a manual switch 128, so that the drive motor 114 may be switched on and off. The drive motor 114 may advantageously be electronically controlled and/or regulated, so that a reversing mode and a desired rotational speed may be implemented. For the reversing mode, the hand-held power tool 100 comprises a rotation direction switching element 121 configured as a rotation direction changeover switch. The rotation direction switching element 121 is configured to switch the drive motor 114 between a clockwise direction of rotation and a counterclockwise direction of rotation. The design and mode of operation of a suitable drive motor are sufficiently well-known to those skilled in the art, which is why they will not be discussed in more detail here.

The transmission 118 is connected to the drive motor 114 via a drive shaft 116. The drive shaft 116 is mounted in the housing 110 by means of a drive shaft bearing 180 and a further drive shaft bearing not shown here; see also FIG. 2. The transmission 118 is intended to convert a rotation of the drive shaft 116 into a rotation between the transmission 118 and the tool holder 150. The transmission 118 comprises a transmission housing 119, a transmission cover 136, and a ring gear 129, wherein the transmission cover 136 at least partially closes the transmission housing 119, see also FIG. 2.

The hand-held power tool 100 configured as a cordless rotary impact screwdriver comprises a rotary percussion mechanism 122 with an intermediate shaft 120; see also FIG. 2. Both the rotary percussion mechanism 122 and the intermediate shaft 120 are located within the housing 110. Preferably, the conversion from rotation of the drive shaft 116 to rotation of the tool holder 150 occurs via the intermediate shaft 120. This conversion takes place such that the intermediate shaft 120 rotates relative to the drive shaft 116 with increased torque, but at a reduced rotational speed. In this case, the drive shaft 116 protrudes into the intermediate shaft 120, for example; see FIG. 2. By way of example, the drive shaft bearing 180 is substantially located in the intermediate shaft 120 such that the drive shaft 116 is substantially supported in the intermediate shaft 120 by means of the drive shaft bearing 180. The rotary percussion mechanism 122 comprises a percussion mechanism housing 123, wherein the rotary percussion mechanism 122 may also be located in another suitable housing, such as the transmission housing 119. The rotary percussion mechanism 122 is configured to drive the output shaft 124. The rotary percussion mechanism 122 comprises a percussion mechanism cover 127 that closes off the rotary percussion mechanism 122 in the direction of the drive motor 114. For example, the percussion mechanism cover 127 and the transmission cover 136 are made as one piece. In addition, the transmission housing 119 and the percussion mechanism housing 123 are made as one piece, for example.

The hand-held power tool 100 comprises a tool axis 102, wherein an axis of rotation of the tool holder 150 forms the tool axis 102. The tool holder 150 is provided on the output shaft 124. The tool holder 150 is preferably molded onto and/or designed on the output shaft 124. The tool holder 150 is preferably located in an axial direction 132 with respect to the drive unit 111. The tool holder 150 is configured here as a hexagon socket, in the form of a bit holder, which is provided to accommodate an insertion tool 140. The insertion tool is configured in the form of a screwdriver bit with a polygonal external coupling 142. The type of the screwdriver bit, for example HEX type, is sufficiently well-known to those skilled in the art. The present disclosure is not limited to the use of HEX screwdriver bits, however; other tool holders that appear useful to the those skilled in the art, such as HEX drills, SDS quick-insertion tools, sockets or round-shank drill chucks, may be used as well. The design and functioning of a suitable bit holder are sufficiently well-known to those skilled in the art as well. The tool holder 150 is rotatably mounted in the percussion mechanism housing 123 and/or the transmission housing 119 by means of a tool holder bearing element 190. The tool holder bearing element 190 is formed as a ball bearing, by way of example, wherein two tool holder bearing elements 190 are provided in this case.

The hand-held power tool 100 comprises a control unit 170 at least for controlling the drive unit 111, in particular the drive motor 114. The housing 110 at least partly accommodates the control unit 170. The control unit 170 comprises a not further depicted microprocessor.

The housing 110 also comprises a power supply holding device 160. The power supply holding device 160 accommodates the hand-held power tool rechargeable battery pack 130 and forms a base 162 comprising a standing surface. The hand-held power tool rechargeable battery pack 130 may be released from the power supply holding device 160 without tools. The housing 110 also comprises the handle 126 and the power supply holding device 160. The handle 126 may be grasped by the user. In one embodiment, the power supply holding device 160 is located on the handle 126. The hand-held power tool 100 may be set down on the base 162.

FIG. 2 shows a section 300 of a longitudinal cross-section of a first embodiment 301 of the hand-held power tool 100. The transmission cover 136 is designed to close off the transmission housing 119, at least in sections. Furthermore, the transmission cover 126 is configured to at least partially engage the ring gear 129. The transmission cover 136 is provided to at least partially engage an inner circumference 266 of the ring gear 129. The ring gear 129 abuts the transmission housing 119, particularly axially. The drive shaft 116 comprises a sealing element 117 that is provided to at least partially seal the transmission 118 and/or the percussion mechanism 122, particularly the rotary percussion mechanism 122, from the drive motor 114. The sealing element 117 is circumferentially arranged about the drive shaft 116. The sealing element 117 is exemplarily connected to the drive shaft 116. The sealing element 117 is arranged axially between the drive motor 114, in particular a spacer element 164 of the rotor 167 of the drive motor 114, and the transmission 118, in particular a planetary gear 262 or planetary gears 262. The hand-held power tool 100 comprises a bearing device 400. The transmission 118 is provided to form the bearing device 400.

The rotary percussion mechanism 122 is connected to the drive motor 114 by means of the transmission 118. The transmission 118 and/or the rotary percussion mechanism 122 comprise the intermediate shaft 120. The intermediate shaft 120 receives the planetary gears 262 of the transmission 118. Furthermore, the intermediate shaft 120 comprises a planet carrier 260 for receiving the planetary gears 262 of the planetary transmission. The intermediate shaft 120 drives the rotary percussion mechanism 122 at least partly. The rotary percussion mechanism 122 comprises a striker 250, at least one percussion mechanism spring 252, at least one percussion mechanism bearing 254, and at least one striking cam 256. The striker 250 and the percussion mechanism spring 252 are located substantially within the percussion mechanism housing 123. In this example, the percussion mechanism spring 252 is configured as a spiral spring. The percussion mechanism cover 127, particularly in the axial direction, is positioned between the rotary percussion mechanism 122, specifically the striker 250 and the percussion mechanism spring 252, and the drive motor 114. The percussion mechanism bearing 254 is provided to connect the striker 250 to the intermediate shaft 120. By way of example, two percussion mechanism bearings 254 are provided. The rotary percussion mechanism 122 also comprises an anvil 270 having an anvil body 272 and at least one anvil cam 274, see also FIG. 2c, wherein two anvil cams 274 are formed. The rotary percussion mechanism 122 drives the striker 250 to the anvil cam 274 by way of the striking cam 256. The tool holder 150 is connected to the anvil 270, wherein the tool holder 150 forms the anvil 270 so they are one piece, by way of example. The intermediate shaft 120 comprises a guiding element 280 provided to guide the striker 250, particularly axially. As the striker 250 is wound up during operation of the rotary percussion mechanism 122, the guiding element 280 guides the striker 250 axially towards the transmission 118 or the drive motor 114, respectively. By way of example, the guiding element 280 is cylindrically formed. The guiding element 280 comprises a guide surface 282 that is provided for the striker 250 to be at least axially guidable on the guide surface 282. The guide surface 282 is formed on an outer circumference of the intermediate shaft 120.

The hand-held power tool comprises a centering device 200. The centering device is configured to center the intermediate shaft 120. The centering device 200 is provided to center the intermediate shaft 120 during both non-impact operation and impact operation. The intermediate shaft 120 is centered relative to the tool axis 102. The centering device 200 is formed on the intermediate shaft 120 and/or on the tool holder 150. A diameter 284 of the guiding element 280 and a diameter 202 of the centering device 200 are substantially the same size.

The transmission cover 136 comprises a transmission receptacle 240. The transmission receptacle 240 is provided to at least partially receive the planet carrier 260 of the transmission 118. The transmission cover 136 forms the transmission receptacle 240, wherein they are one piece. The transmission receptacle 240 is shaped like a bowl, as an example. The transmission receptacle 240 at least partially receives the planet carrier 260 of the transmission 118, at least in sections. The transmission receptacle 240 is also formed here as an intermediate shaft receptacle 242.

The hand-held power tool 100 comprises a play compensation element 330. The play compensation element is arranged, particularly axially, between the transmission cover 126 and the ring gear 129. The play compensation element 330 is provided to compensate for axial play and/or radial play. The play compensation element 330 compensates for the axial play by applying an axial force to the ring gear 129, to the intermediate shaft 120, from the intermediate shaft 120 to the anvil 270, and correspondingly to the tool holder 150. The play compensation element 330 is provided to pretension the intermediate shaft 120 against the anvil 270. The play compensation element 330 is provided to seal the transmission 118 from grease leakage. The play compensation element 330 is formed as a spring member, such as an O-ring, for example. Here, the transmission cover 136 is arranged axially between the play compensation element 330 and the planetary gear 262 of the planetary transmission. The play compensation element 330 abuts the transmission receptacle 240. The play compensation element 330 is arranged radially between the transmission receptacle 240 and the ring gear 129. The ring gear 129 comprises a ledge 340. The transmission cover 136 is provided to apply force to the ledge 340 of the ring gear 129. The ledge 340 is formed as an at least partially circumferential ledge 340. The ring gear 129 forms the ledge 340 so that it is one piece. The ledge 340 of the ring gear 129 is a ledge 340 formed in the direction of the drive shaft 116. The transmission cover 136 applies force to the ledge 340 of the ring gear 129 via the play compensation element 330. The play compensation element 330 abuts the ledge 340 of the ring gear 129. The transmission cover 136 at least partially abuts the ring gear 129. The ring gear 129 secures the transmission cover 136 axially at least in part via the ledge 340. The axial forces are thereby introduced into the ring gear 129 via the transmission cover 136, the play compensation element 330, and the ledge 340. The transmission cover 136 is formed as a thrust washer. As an example, the thrust washer is formed as thin sheet metal. A wall thickness 242 of the transmission cover 136, particularly the thrust washer, is less than 1.5 mm.

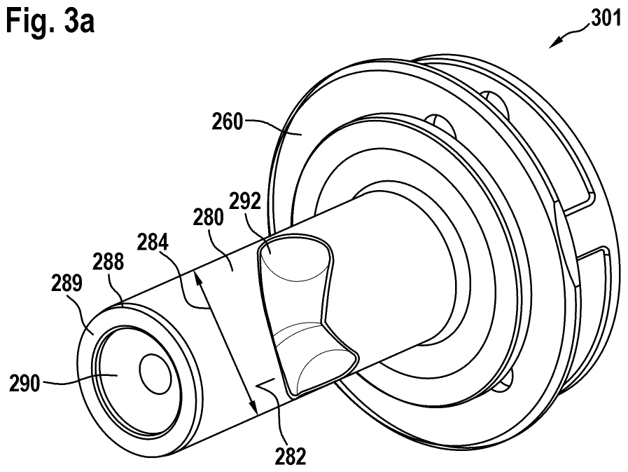

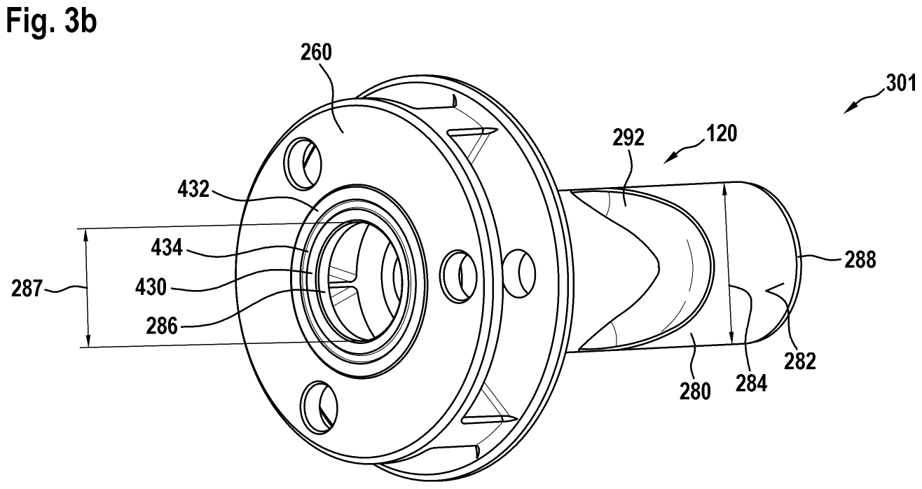

The bearing device 400 comprises an axial bearing device 420. The axial bearing device 420 is at least partially, particularly axially, formed between the intermediate shaft 120 and the transmission cover 136. The axial bearing device 420 is formed such that the intermediate shaft 120 can be oriented relative to the transmission cover 136. The axial support device 400 comprises at least one bearing element 430, see also FIGS. 3b, 6, 7. The bearing element is formed circumferentially in the direction of the drive shaft 116. By way of example, the bearing element 430 is formed on the intermediate shaft 120, in particular the planet carrier 260. The intermediate shaft 120, in particular the planet carrier 260, is connected to the bearing element, wherein they are one piece here. By way of example, the bearing element 430 is formed as a circumferential web. The bearing element 430 is radially arranged between the drive shaft 116 and the ring gear 129. Here, the bearing element 430 is exemplarily radially arranged between the drive shaft 116 and planetary gear bolts 264 of the planetary gears 262 of the transmission 118. The planetary bolts 264 are provided to rotatably position the planet gears 262 on the planet carrier 260. The axial bearing device 420 comprises at least one bearing receptacle 422. The bearing receptacle 422 is provided to receive the bearing element 430. By way of example, the bearing receptacle 422 is arranged and formed on the transmission cover 136 such that the bearing receptacle 422 and transmission cover 136 are one piece. The bearing receptacle 422 receives the bearing element 422 such that the intermediate shaft 120 is supported relative to the transmission cover 136. The bearing receptacle 422 is formed circumferentially in the direction of the drive shaft 116. For example, the bearing receptacle 422 is formed as a bearing surface that is shaped like a disc. The bearing receptacle 422 is formed by the transmission cover 136, as an example. The axial support device 420 comprises at least one further bearing element 432. The bearing element 430 is radially arranged between the drive shaft 116 and the further bearing element 432. The further bearing element 432 is arranged in the circumferential direction with respect to the drive shaft 116. The further bearing element 432 is formed as a circumferential web. The bearing receptacle 422 is shaped such that both the bearing element 430 and the further bearing element 432 are receivable. The bearing device 400 comprises at least one lubricant receptacle 434. The lubricant receptacle 434 is formed to receive lubricant of the bearing device 400. The lubricant receptacle 434 receives the lubricant, such as grease, like transmission grease. The lubricant receptacle 434 is arranged radially between the bearing element 430 and the further bearing element 432. By way of example, the lubricant receptacle 434 is formed as a circumferential groove. The lubricant receptacle 434 is arranged and formed on the intermediate shaft 120, in particular the planet carrier 260. Thus, the lubricant receptacle 434 is one piece with the intermediate shaft 120, particularly the planet carrier 260. The bearing device 400 comprises a radial bearing device 440. The radial bearing device 440 is formed at least partially, in particular radially, between the intermediate shaft 120 and the ring gear 129. The bearing device 400 comprises the axial bearing device 420 and the radial bearing device 440. At least one of the planetary gears 262 of the transmission 118 and the ring gear 129 are configured to form the radial bearing device 440. Here, a plurality of planet gears 262 is provided, by way of example, three planet gears 262. The radial bearing is carried out substantially indirectly via the three planetary gears 262.

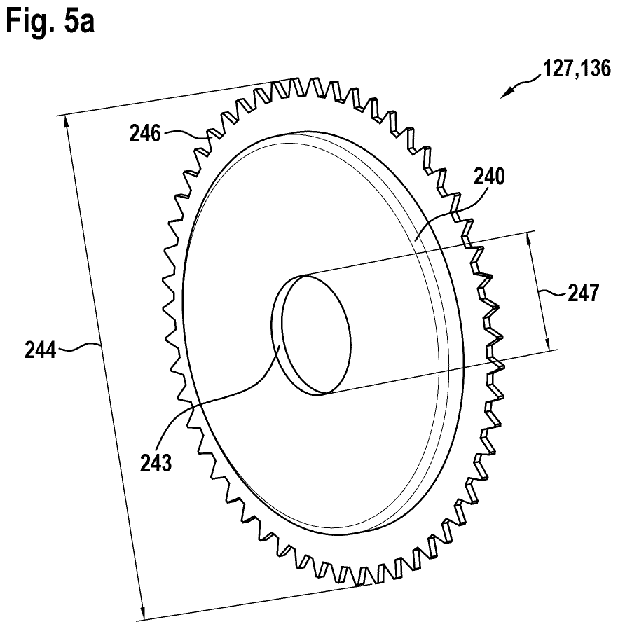

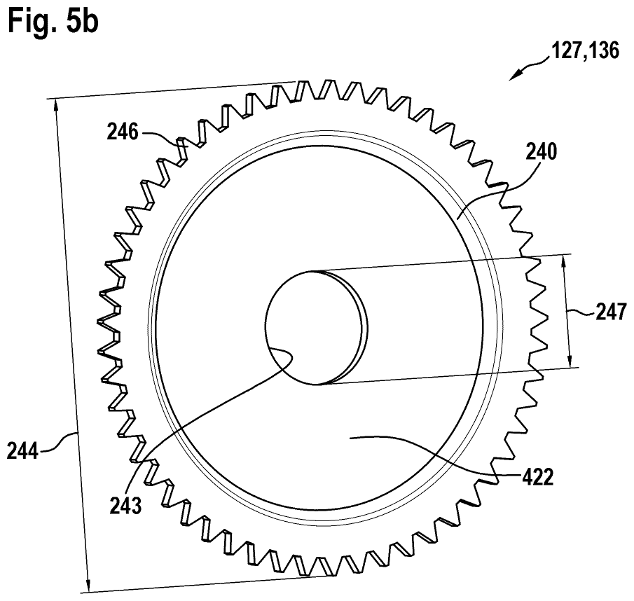

The transmission cover 136 comprises a central opening 243. The intermediate shaft 120 comprises a central opening 286. The opening 243 of the transmission cover 136 is smaller or substantially equal to the opening 286 of the intermediate shaft 120. The drive shaft 116 is guided through the opening 243 of the transmission cover 136 and through the opening 286 of the intermediate shaft 120 into the transmission 118. A diameter 247 of the opening 243 of the transmission cover 136 is smaller or substantially equal to a diameter 287 of the opening 286 of the intermediate shaft 120, see also FIGS. 3b and 5. The opening 243 of the transmission cover 136 and the opening 186 of the intermediate shaft 120 are arranged axially adjacent to one other. In addition, the opening 286 of the intermediate shaft 120 comprises a ramp, in which the diameter 287 of the opening 286 of the intermediate shaft 120 increases from motor side to tool side.

The centering device 200 and the anvil 270 are arranged at least partially overlapping each other. The centering device 200 and the anvil 270, in particular the anvil cam 274, at least partially overlap, in particular axially, see also FIG. 2c. In addition, the intermediate shaft 120 is arranged at least partially overlapping the anvil 270, in particular the anvil cam 274, see also FIG. 2c. The centering device 200 comprises a centering receptacle 210. The centering receptacle is configured to at least partially encompass the intermediate shaft 120. Here, by way of example, the anvil 270 at least partially forms the centering device 200. The centering receptacle 210 is formed as a centering recess, wherein the centering receptacle 210 is formed opposite to the tool holder 150. By way of example, the centering receptacle 210 is shaped like a bowl. A diameter of the centering receptacle 210 here matches the diameter 202 of the centering device 200. The diameter of the centering receptacle 210 is substantially the same as the diameter 284 of the guiding element 280. The intermediate shaft 120 may be rotated relative to the tool holder 150. The centering receptacle 210 at least partially encompasses the intermediate shaft 120, in particular the guiding element 280. The centering receptacle 210 is radially arranged between the intermediate shaft 120 and the striker 250, in particular the striking cam 256, see also FIG. 2c. The centering device 200 comprises a centering collar 212. The centering collar is formed to at least partially abut the intermediate shaft 120. Here, the centering collar 212 is formed on the anvil 270, wherein it is formed as a circumferential web. The centering collar 212 at least partially abuts the intermediate shaft 120, particularly the guiding element 280. Thus, the centering device 200 centers the intermediate shaft 120 via the centering collar 212. The tool holder 150 is centered over the tool holder bearing element 190. The centering collar 212 can be arranged at least partially overlapping the striker 250. The centering collar 212 is formed on the anvil 270. During non-impact operation, the centering collar 212 and the striker 250, particularly the impact body 258 overlap. The centering collar 212 extends into a closed striker diameter in a striker position. Here, the centering collar 212 is arranged radially between the intermediate shaft 120 and the striker 250, in particular the striking body 258. The intermediate shaft 120 comprises at least one abutment element 288. The abutment element 288 is configured to at least partially abut the centering device 200 and receive at least axial forces of the centering device 200. The abutment element 288 is formed on an end face 289 of the intermediate shaft 120, see also FIG. 3a. The end face 289 is facing toward the tool holder 150. The abutment element 288 is at least partially ring shaped. Here, the abutment element 288 abuts the centering device 280 directly. The centering receptacle 210 receives the abutment element 288. The abutment element 288 is arranged at least partially, in particular axially, overlapping the anvil 270, in particular the anvil cam 274, see also FIG. 2c.

The intermediate shaft 120 comprises a compensating element 290. The compensating element 290 is formed to compensate for imbalances. The compensating element 290 is formed as a conical bore in the intermediate shaft 120, see also FIG. 3a. The centering device 200 comprises a centering element 220. The centering element 220 is configured to at least partially engage the intermediate shaft 120. Here, the centering element 220 is exemplarily formed by the anvil 270, wherein they are made of one piece. By way of example, the centering element 220 is formed as a centering cone, see also FIGS. 2c and 2d. The centering element 220 is configured to at least partially engage the compensating element 290 of the intermediate shaft 120. The abutment element 288 of the intermediate shaft 120 at least partially encompasses the centering element 220 in a circumferential direction.

FIG. 2b shows a section of a cross-section in A-A direction of the first embodiment 301 of the hand-held power tool 100. An outer diameter 244 of the transmission cover 136 is less than a base diameter 342 of the ring gear 129, see also FIG. 5. The outer diameter 244 of the transmission cover 136 is smaller than the base diameter 342 of the ring gear 129 such that the transmission cover 136 can be inserted within the ring gear 129. The transmission cover 136, particularly the thrust washer, comprises a sprocket 246. The sprocket 246 of the transmission cover 136 is provided to engage the ring gear 129. The sprocket 246 is formed on an outer circumference of the transmission cover 136, see also FIG. 5. For example, the sprocket 246 and the transmission cover 136 are made as one piece. The sprocket 246 is formed to be directed radially outward. The sprocket 246 of the transmission cover 136 is insertable into a sprocket 344 of the ring gear 129. The sprocket 246 of the transmission cover 136 and the sprocket 344 of the ring gear 129 interlock with toothing.

FIG. 2c shows a section of a longitudinal cross-section of the first embodiment 301 of the hand-held power tool 100. The centering collar 212 at least partially encloses the centering receptacle 210. The anvil cam 274 is arranged axially between the centering collar 212 and the tool holder 150. FIG. 2d shows a perspective view of the tool holder 150 with the anvil 270 of the first embodiment 301 of the hand-held power tool 100.

FIG. 3a shows a first perspective view of the intermediate shaft 120 of the first embodiment 301 of the hand-held power tool 100 and FIG. 3b shows a second perspective view of the intermediate shaft 120 of the first embodiment 301 of the hand-held power tool 100. The intermediate shaft 120 comprises at least one guiding groove 292. The guiding groove 292 is configured to receive and guide the percussion mechanism bearing 254. By way of example, two guiding grooves 292 are provided that are substantially V-shaped.

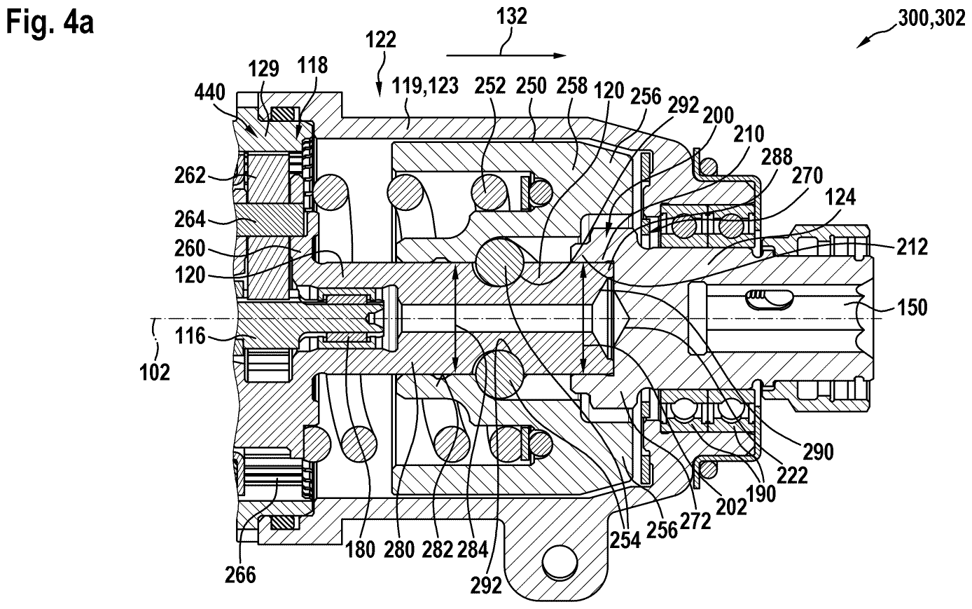

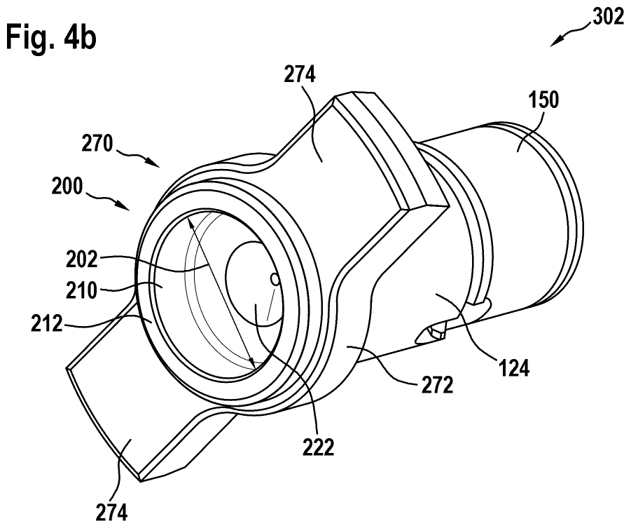

FIG. 4a shows a section of a longitudinal cross-section of a second embodiment 302 of the hand-held power tool 100. FIG. 4b shows a perspective view of the tool holder 150 with the anvil 270 of the second embodiment 301 of the hand-held power tool 100. In the second embodiment 302, the centering device 200 comprises a collection element 222. The collection element is provided for collecting at least lubricants. By way of example, the collecting element 222 is formed by the anvil 270, wherein the collection element 222 is formed by way of example as a blind hole with a centering bore.

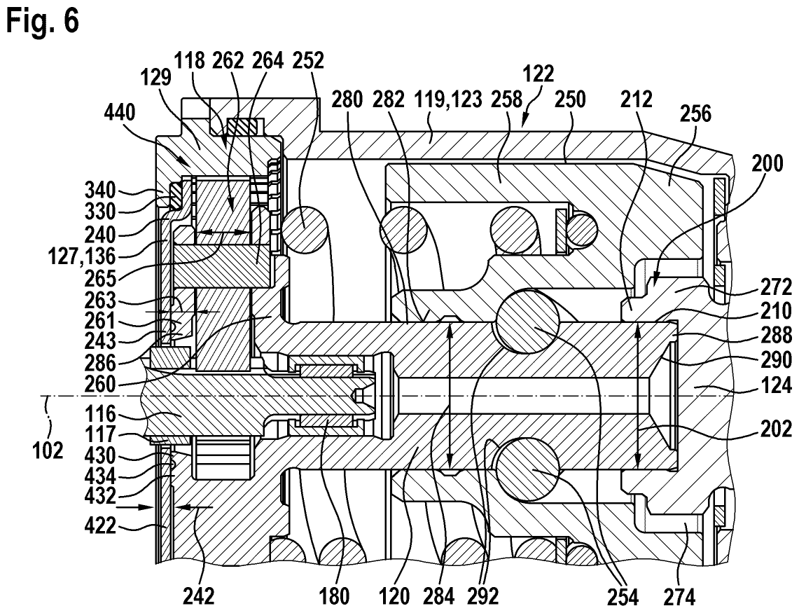

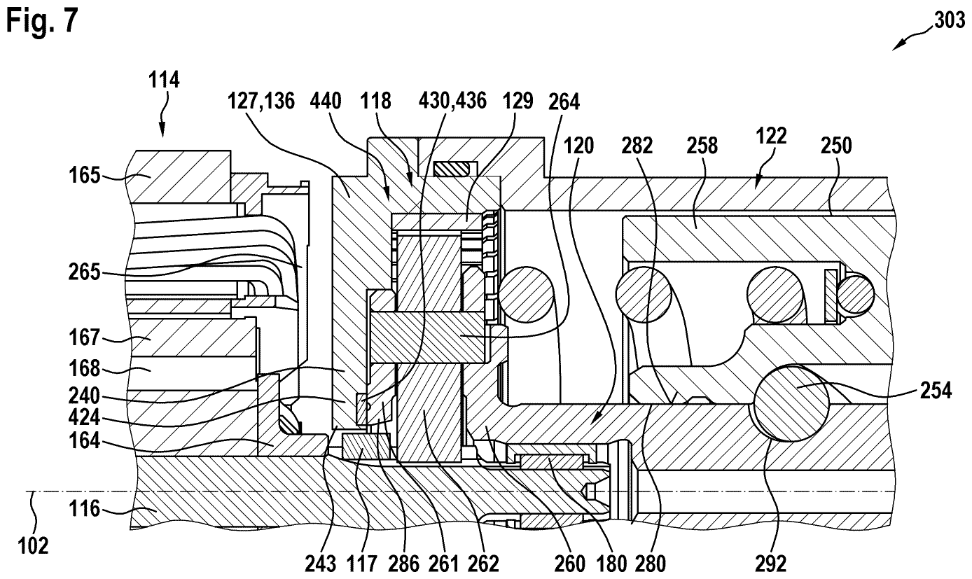

FIG. 5a shows a first perspective view of the transmission cover 136 of the hand-held power tool 100, whereas FIG. 5b shows a second perspective view of the transmission cover 136 of the hand-held power tool 100. FIG. 6 shows a section of a longitudinal cross-section of the hand-held power tool 100. At least one width 263 of a planet carrier flange 263 of the transmission 118 is less than or substantially equal to at least one width 265 of a planetary gear 262 of the transmission 118. The planet carrier flange 261 is a flange of the planet carrier 260. FIG. 7 shows a section of a longitudinal cross-section of a third embodiment 303 of the hand-held power tool 100. Here, the bearing element 430 is formed by a separate component 436, wherein the separate component is annular in shape. The separate component 436 is arranged axially between the gear cover 136 and the intermediate shaft 120, particularly the planet carrier 260, quite particularly the planet carrier flange 261. By way of example, the transmission cover 136 comprises a receptacle 424 for the separate component. For example, the ring gear 129, the transmission cover 136 and the percussion mechanism cover 127 are made as one piece.

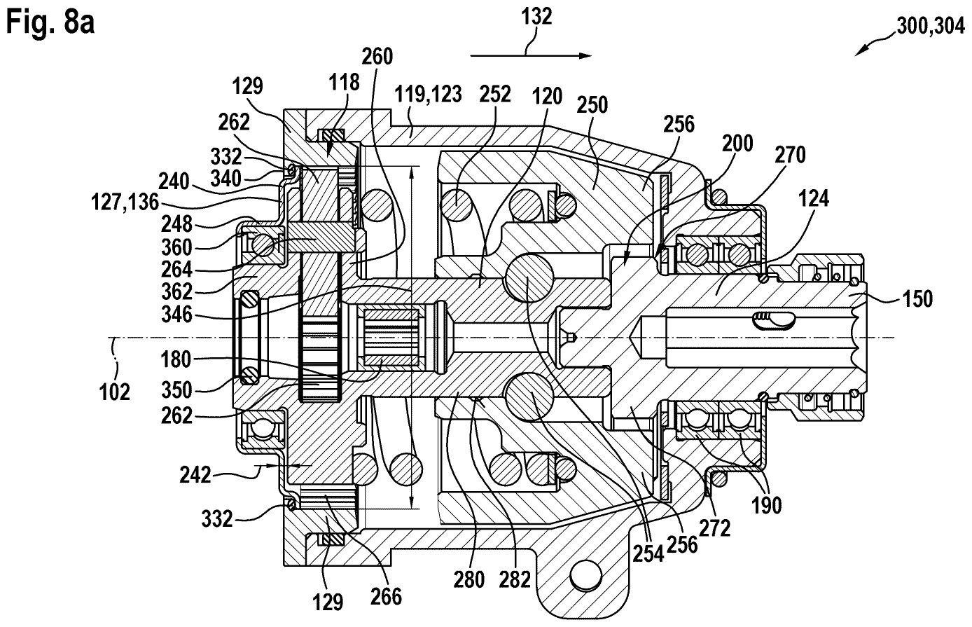

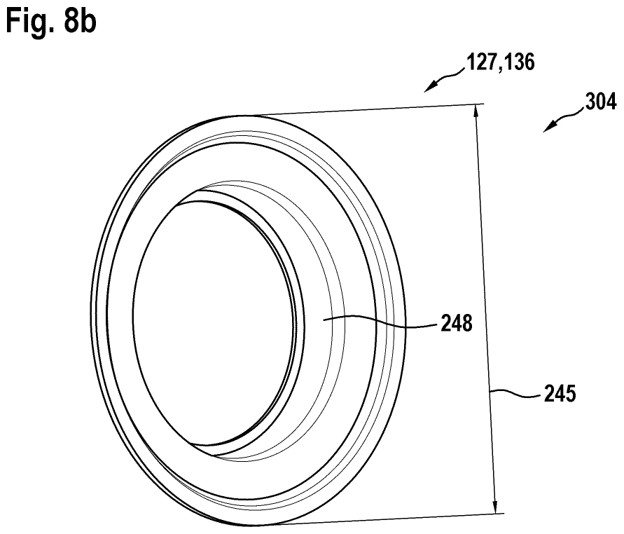

FIG. 8a shows a section 300 of a longitudinal cross-section of a fourth embodiment 304 of the hand-held power tool 100. An intermediate shaft bearing element 360 is arranged between the intermediate shaft 120 and the transmission cover 136. The intermediate shaft bearing element 360 is thus arranged radially between the intermediate shaft 120 and the transmission cover 136. The intermediate shaft bearing element 360 is configured as a ball bearing, for example. The intermediate shaft 120 comprises a bearing receptacle 362 formed as a circumferential collar, for example. The planet gears 262 are arranged, particularly axially, between the intermediate shaft bearing element 360 and the drive shaft bearing 180. The transmission cover 136 may include an intermediate shaft bearing receptacle 248. The intermediate shaft bearing element 360 is arranged radially between the bearing receptacle 362 and the intermediate shaft bearing receptacle 248. The intermediate shaft 120 comprises a sealing ring 350. The sealing ring 350 substantially seals the not-shown drive shaft 116. The sealing ring 350 is then arranged radially between the not-shown drive shaft 116 and the intermediate shaft. A damping element 332 is provided that is arranged between the transmission cover 136 and the ring gear 129. The damping element 332 is shaped as an O-ring, by way of example. The damping element 332 is configured to attenuate possible vibrations. The ring gear 129 comprises a top diameter 346. The transmission cover 136 is guidable at least in part by means of the top diameter 346.

FIG. 8b shows the transmission cover 136 in the fourth embodiment 304 of the hand-held power tool 100. The transmission cover 136, with an outer diameter 245, abuts the top diameter 346.

1. A hand-held power tool comprising:
a housing;
a drive motor comprising a drive shaft;
a transmission driven by the drive shaft;
an intermediate shaft driven by the transmission, the intermediate shaft comprising:
a percussion mechanism comprising a striker and an anvil; and
a guiding element configured to guide the striker;
a centering device configured to center the intermediate shaft, the centering device having a diameter that is substantially the same size as a diameter of the guiding element; and
a tool holder driven by the percussion mechanism and configured to receive an insertion tool.

2. The hand-held power tool according to claim 1, wherein the centering device and the anvil are arranged at least partially overlapping each other.

3. The hand-held power tool according to claim 1, wherein the centering device comprises a centering receptacle configured to at least partially encompass the intermediate shaft.

4. The hand-held power tool according to claim 1, wherein the centering device comprises a centering collar configured to at least partially abut the intermediate shaft.

5. The hand-held power tool according to claim 4, wherein the centering collar is arranged at least partially overlapping the striker.

6. The hand-held power tool according to claim 1, wherein the intermediate shaft comprises at least one abutment element configured to at least partially abut the centering device and receive at least axial forces from the centering device.

7. The hand-held power tool according to claim 6, wherein the at least one abutment element is arranged at least partially overlapping the anvil.

8. The hand-held power tool according to claim 1, wherein the intermediate shaft comprises a compensating element configured to compensate for imbalances.

9. The hand-held power tool according to claim 1, wherein the centering device comprises a centering element configured to at least partially engage the intermediate shaft.

10. The hand-held power tool according to claim 1, wherein the centering device comprises a collection element configured to collect at least lubricants.
